(19) United States
(12) Patent Application Publication
(10) Pub. No.: US 2008/0010142 A1
(43) Pub. Date: Jan. 10, 2008

(54) On-line marketing optimization and design method and system

(75) Inventors: Matthew Charles O'Brien, Scottsdale, AZ (US); Christopher Wayne Bown, Phoenix, AZ (US); Dale Edward Merritt, Phoenix, AZ (US)

Correspondence Address: JENNINGS, STROUSS & SALMON, P.L.C., 201 E. WASHINGTON ST., 11TH FLOOR, PHOENIX, AZ, 85004, US

(73) Assignee: Internet Real Estate Holdings LLC

(21) Appl. No.: 11/475,495

(22) Filed: Jun. 27, 2006

(51) Int. Cl. G06Q 30/00

(52) U.S. Cl. 705/14

(57) ABSTRACT

A marketing and database indexing tool for promotion of existing web sites is disclosed. The web site marketing tool, through the creation, generation, optimization and standardization of graphical site maps, is capable of driving traffic from search engines to call to action pages, which is then capable of increasing the response rate of a web site. With the addition of a site map tool, web site content can be standardized for creating the highest level of relevancy with search engines. The site map tool is capable of distributing page relevancy from a site's best page to every page of the web site. Thus, the disclosed marketing and database indexing tool increases the visibility of each web site page and improves the ROI (return on investment) of online marketing.

### CROSS REFERENCE TO RELATED APPLICATIONS

This application claims the benefit of priority of U.S. Provisional Application Ser. No. 60/693,974, filed Jun. 24, 2005.

### FIELD OF THE INVENTION

This invention relates to methods and systems for on-line marketing. More specifically, this invention relates to tools and systems for on-line marketing that include site search engine optimization.

### BACKGROUND OF THE INVENTION

E-commerce is the fastest growing segment of the B2B market. Companies are looking for ways to make their web sites accessible to businesses and consumers, and they are selling products and services on the Internet in increasing numbers. The Internet has created a tremendous opportunity to expand into new markets and reach new market segments. There is also tremendous competition to obtain and retain customers.

A variety of methods and systems for marketing over the Internet are well known in the art. Although not necessarily qualifying as “prior art” the following U.S. patent documents are referred to the reader for background information: U.S. Pat. Nos. 6,006,218; 6,594,654 B1; and 6,801,906 B1. The content of these documents is hereby incorporated by reference in its entirety for the material contained therein.

Generally, these prior methods and systems fail to consider the ranking process of commonly-used Internet search engines and, therefore, fail to provide tools for increasing the web site relevancy and/or ranking of these Internet search engines. Particularly, such prior methods and systems fail to provide a technique for making each page of a web site accessible to search engines.

Therefore, a need exists for powerful web site marketing tool that is capable of driving traffic from search engines to call-to-action pages, which in turn has the capability of increasing the response rate of a web site (sales and leads) plus the capability of being translated into an off-line design tool that can create marketing materials (brochures, posters, etc.) from the images and content on a web site.

### SUMMARY OF THE INVENTION

It is desirable to provide a method and system for on-line marketing that emphasizes the placement and ranking of web sites on major commonly-used search engines. More specifically, it is desirable to provide such a method and system that includes a set of software tools for improving the results and ranking of search engines of web sites and to thereby increase web site traffic.

Accordingly, it is an object of an embodiment of this invention to provide a method and system for improving the marketing results for web sites by improving the ranking or relevancy of the web site by the commonly-used search engines.

It is an object of an embodiment of this invention to provide a method and system for improving the marketing results of web sites that includes a database indexing tool that aids in standardizing web site content for creating the highest levels of relevance with search engines.

It is an object of an embodiment of this invention to provide a method and system from improving the marketing results of web sites that includes a tool for creating a graphical site map with the content of each web site page.

It is an object of an embodiment of this invention to provide a method and system form improving the marketing results of web sites that includes a tool for distributing the top page rank from the web sites' best page to every page of the web site.

It is an object of an embodiment of this invention to provide a method and system from improving the marketing results of web sites that includes a tool for optimizing web sites to further improve search engine marketing results.

It is an object of an embodiment of this invention to provide a method and system for improving the marketing results of web sites that includes a design tool for creating marketing materials from the images and content on a web site.

It is an object of an embodiment of this invention to provide a method and system for improving the marketing results of web sites that provides for the standardization of web site content and images for both on-line and off-line marketing.

It is a further object of some embodiments of this invention to provide a method and system for improving the marketing results of web sites that includes a “favorites” feature.

It is a further object of some embodiments of this invention to provide a method and system for improving the marketing results of web sites that includes a data capture function.

It is a still further object of some embodiments of this invention to provide a method and system for improving the marketing results of web sites that includes the capability of adding advertising space to the web sites.

It is a still further object of some embodiments of this invention to provide a method and system for improving the marketing results of web sites that includes the capability for a user to view, edit and reposition the web site map.

Additional objects, advantages and other novel features of this invention will be set forth in part in the description that follows and in part will become apparent to those skilled in the art upon examination of the following or may be learned with the practice of the invention. The objects and advantages of this invention may be realized and attained by means of the instrumentalities and combinations particularly pointed out in the appended claims. Still other objects of the present invention will become readily apparent to those skilled in the art from the following description wherein there is shown and described several preferred embodiments of this invention, simply by way of illustration of modes of the invention suited to carry out this invention. As it will be realized, this invention is capable of other different embodiments, and its several details, steps, and specific features are capable of modification in various aspects without departing from the invention. Accordingly, the objects, drawings and descriptions should be regarded as illustrative in nature and not as restrictive.

### BRIEF DESCRIPTION OF THE DRAWINGS

The accompanying drawings incorporated in and forming a part of the specification, illustrate one or more embodiments of the present invention.

FIG. 1 is process diagram of the top-level steps of the present embodiment of the disclosed system and method.

FIG. 2A is a system flow diagram of one embodiment of the disclosed system and method.

FIG. 2B is a system flow diagram of an alternate embodiment of the disclosed system and method.

FIG. 2C is a technical flowchart showing the specific steps of the disclosed method.

FIGS. 2D and 2E illustrate various components of the method shown in FIG. 2C.

FIGS. 3A, 3B and 3C are representative screen diagrams of several steps in the present embodiment of this disclosed system and method.

FIGS. 3D and 3E are examples of the off-line marketing component of the disclosed system and method.

FIG. 4 is a detailed view of the system flow between the components of the present embodiment of this disclosed system and method.

FIG. 5 is an example of a screen diagram of the use of the favorites feature in the present embodiment of this disclosed system and method.

FIG. 6 is a detailed process diagram of the off-line design process of the present embodiment of this disclosed system and method.

### DETAILED DESCRIPTION OF VARIOUS EMBODIMENTS

This following detailed description illustrates a marketing and database indexing tool for promotion of existing web sites. The disclosed web site marketing tool drives traffic from search engines to call-to-action pages, which is capable of increasing the response rate of a web site (sales and leads). With the addition of a site map tool, web site content can be standardized for creating the highest level of relevancy with search engines. The site map tool is capable of distributing web page relevancy from a site's best page to every page of the web site. Thus, the disclosed marketing and database indexing tool increases the visibility of each web site page and improves the ROI (return on investment) of on-line marketing.

Additionally, the disclosed system and method leverages the current web site of a business to build the foundation for the on-line and off-line marketing. The disclosed system and method utilizes available web site content and marketing, optimization and design standards (MODS) to draw niche traffic, do data capture and increase sales to a defined target market. The disclosed target marketing tools allow users to enhance their on-line marketing spending by reaching the desired audience.

Further, the disclosed system and method standardizes web site content and images for on-line and off-line marketing through a user-friendly web-based system. The disclosed system and method is capable of serving as the foundation for all web site marketing (on-line and off-line) and becoming an international Internet marketing and indexing standard. The disclosed system and method is capable of converting web site content into multiple languages, thus increasing accessibility to the global marketplace. The disclosed system and method allows web sites to be recreated into multiple viewing formats and languages, get sites indexed (listed) with any type of on-line database and bring customers to the call-to-action pages.

Finally, the back-end component of the disclosed system and method has a tracking mechanism that enables the collection of user data demographics and psychographics, such as what are consumers' favorite products, buying patterns, browsing habits and other powerful aggregate data.

In particular, the following discloses a system and method for the promoting web sites as a marketing tool both on-line and off-line. In particular, the system and method provide the capability of improving the ranking or relevance of a web site when accessed by the standard search engines. The present embodiment of this invention includes, in its preferred embodiment, a variety of modules or functions, which work together to improve the effectiveness of on-line marketing. Included among these modules or functions are (1) a search engine marketing tool which can have the effect of distributing the relevancy of the top page to the other pages on a site to every page on the web site of interest; (2) a database indexing tool which aids in normalizing data for creating the highest level of relevance for selected search engines; (3) a site map tool, that by creating an HTML graphical site map for web viewers and search engine spiders, maximizes search engine results and provides deep indexing for all pages of an entire web site; (4) an interactive off-line document production tool that integrates and incorporates the design features of the web site; (5) a tracking tool for the collection of user data, demographics and psychographics, such as consumer favorite products, buying patterns, browsing habits and other aggregate data; (6) an on-line lead generation module for the creation of micro-sites to produce a stream of high volume, high quality and demographically focused sales leads; and (7) a favorites tool that enables the customization of a user's browser and permits the user to create graphical bookmarks, favorites and to categorize web pages by preferences.

More specifically, the search engine marketing, optimization and indexing tool includes at least the following components: (1) an HTML graphical site map for web viewers and search engine spiders; (2) an administrative tool aids with assignment of title, description and key word for each web page for the search engine indexing process; and a tool that enables the user to adjust the layout, add text and set the page to adjust to changing search engine techniques and categorizing Web sites for key word relevance and placement.

Further, in one embodiment, the on-line sales and lead generation aspect of the disclosed system and method (1) allows for the creation of micro-sites to produce a stream of high volume, high quality, and demographically focused sales and/or leads; (2) is a transparent marketing skin that is designed to funnel both on-line and off-line prospects into a call-to-action web page that generates a response; and (3) provides for built-in business intelligence features that allow a user to define target markets.

Additionally, in one embodiment, the off-line marketing tools of the disclosed system and method include (1) print marketing tools that leverage content and design of existing web sites to create off-line print materials that drive prospects on-line; (2) the capability to improve a company's sales and off-line lead process through interactive brochures with CDs and DVDs and off-line marketing through promotional games; (3) a direct mail piece combining a marketing brochure with an interactive CD-ROM that generates a call-to-action from a target market; (4) a promotional marketing tool that drives people on-line to a data capture to retrieve a prize where the end-user is forwarded to the sponsor's web site; and (5) the “touch and feel” credibility of printed materials with on-line data capture.

Further, in one embodiment, the disclosed system and method includes an on-line advertising and affiliate marketing tool that is capable of (1) leveraging any web site and product content to create multiple product views, price comparisons, and product features comparisons while providing customized viewing and shopping options; (2) presenting web page content and products in the site map format described herein; (3) providing standardized tools to import and populate affiliate data feeds into a web site; (4) providing a novel administrative tool for view and tracking activity and sales from dissimilar affiliate programs; (5) capturing aggregate data to determine purchasing trends and demographic profiles of end users; and (6) providing users of the system and method with demographic data to target web users with their ads and products.

In an alternate embodiment, the disclosed system and method also includes a search marketing directory which includes an on-line directory utilizing the site map format described herein to expedite the search engine indexing and ranking. In a further embodiment, this function is capable of functioning as a search engine in and of itself.

Further, in another embodiment, the disclosed system and method includes marketing, optimization and design software (defined herein as MODS). The MODS aspect of the disclosed system and method includes a data mining module which includes the capability of providing a customer and prospect predictive modeling analysis tool that profiles and populates demographic data and trends for target marketing; data capture tools to identify end user demographic data upon registration and track Internet activity; and the ability to enable corporate or e-commerce sites to analyze traffic and mine data from the end users.

The MODS aspect also includes graphical bookmarks and favorites that enable Internet users to configure their browser using a customizable format; a consumer web browser that is capable of launching one-page access to their favorite web sites and the ability of web users to create graphical bookmarks and favorites and to categorize web pages by preferences. Further, the MODS aspect may also include site map enhancements where multiple versions of the site map can be developed, including multi-language, industry standards, search engine indexing, and more.

Overall, this disclosed system and method comprised of the above-described tool set is advantageous over the existing marketing systems in part because it is capable of enhancing the marketing effectiveness of web sites, which provides for the promotion of web sites both on-line and off-line and that includes a database indexing tool for standardizing web site content and that creates the highest level of relevance with search engines. This tool set is also capable of creating a graphical web site map with the web site content of every page. This tool set also includes a design tool for using on-line web site content for creating off-line publications along with standardization and favorites capabilities.

This disclosed system and method makes use of a technique called “search advertising.” Search advertising draws a huge audience of Internet users with a specific and active focus, clearly expressed in the search keywords they have entered. Keyword targeted advertising programs are poised to deliver the Internet marketing benefits that have long been promised from on-line advertising, namely measurable results and fine-tuned targeting. Search driven advertising is delivered by means of a trigger or keyword. Keywords are the advertiser's window into the customer's thinking and are the most important basis for directing an advertising message to precisely those people who want to see it.

While a single keyword can describe a motivation or interest and implies a wish to take further action, a list of keywords can provide a snapshot of the people who use them. Although inherently incomplete, the list of keywords can be uncannily accurate in its ability to bring buyers and sellers together. At its essence keyword search advertising operates in the following manner. An advertiser selects a set of keywords to be associated with their web site(s). When a potential customer performs a keyword search, if any of the customer's entered keywords match those selected by the advertiser, the advertiser's web site or advertisement is presented to the customer.

The following is a glossary of terms used in the description of this invention and used in the field of Internet advertising and marketing.

Advertising Metrics Quality- and performance-based metrics used in an Internet search advertising campaign. Ideally, these metrics record measurements indicating the effectiveness of the advertising campaign and are often used as the basis for ad pricing models on sites. Typical advertising metrics include: target audience, universe, impression, reach, share of voice, unique user, repeat visitor, frequency, clickthrough, clickthrough rate, return on investment, conversion, conversion rate and tracking.

Advertising Pricing The costs for search advertising typically based on ad delivery—usually measured in or on actual ad performance. Typically, performance-based pricing relies on a set of agreed upon metrics, such as cost-per-click (CPC), percentage of on-line revenues and/or delivery of new sales leads. Some publishers also offer hybrid models, which combine the benefits of CPM and performance-based pricing.

Animated Ad: An ad with movement, often an interactive Java applet or a Shockwave or GIF89a file.

Banner Ad: A graphic image, usually a GIF or JPEG, that can be placed anywhere on a web page, most frequently centered across the top of the web page. The tile ad is a small counterpart, typically grouped with other tile ads along a side margin. The standard banner ad is presently 468×60 pixels; the most common size for tile ads is 125 pixels.

Beacon: A line of code placed in an ad or on a web page that helps track the visitor's actions, such as registrations or purchases. A web beacon is often used because it is typically only 1×1 pixel in size and has no color. This is also referred to as a web bug, 1 GIF, invisible GIF or tracker GIF.

Beyond-the-Banner: Any advertisement that is not a banner, such as an interstitial or a pop-up ad.

Bidding Managers: Tools, which are useful for paid search engine rankings by helping with researching, managing and price optimizing paid listings.

Broad Match: An ad appears when the words in the keyword are contained in the query, regardless of the order and even if other words are also included. For example, a broad match for the keyword “tennis shoes” would include “shoes for tennis” and “tennis dresses and shoes.” Broad matches are usually less targeted than exact or phrase match.

Button: A clickable graphic that takes the user to another page or executes a program, such as a software demo or a video player.

Call-to-Action: An ad copy that encourages users to take a defined action. Examples are “Click here,” “Buy now” or “Click to download a free white paper.”

Click-Down Ad, also Click-Within-Ad: An ad that allows the user to stay on the same web page, while viewing requested advertising content. Click-downs displaying another file on the user's screen normally appear below or above the initial ad. Click-withins allow the user to drill down for more information within the ad.

Clickthrough: The action of clicking an ad element and causing a redirect to another web page.

Clickthrough Rate (CTR): The number of clickthroughs divided by the number of impressions, multiplied by 100 and expressed as a percentage. For example, one CTR is one percent if 100 people are shown the ad and one person clicks through to the clickthrough site. CTRs typically range from about 0.5 percent for banner ads to 3.0 percent for text links. This is also known as ad impression ratio or yield.

Cookie: A file on the user's browser that uniquely identifies him or her. Use of cookies on a web site can make it possible to identify return visitors and their web actions.

Context Integration Advertising woven into editorial content or placed in a special context on the page, typically appearing on portals and large destination sites. Also known web advertorial or sponsored content.

Conversion: A defined action in response to an ad's call-to-action. A conversion may be a sale, a registration, a download or an entry into a database, depending on the goal of the ad campaign.

Conversion Rate The number of visitors who respond to the ad's call for action as divided by the number of impressions, multiplied by 100 and expressed as a percentage. For example, the conversion rate is one percent if 100 people are shown the ad, five people clickthrough to the site and one person makes a purchase.

Cost-per-1000-Impressions (CPM): Pricing based on number of impressions served over a period of time. For example, a $50 CPM means the cost is $50 for every 1000 times an ad appears. This is also referred to as pay-by-impression.

Cost-per-Action (CPA): Pricing based on the number of actions in response to an ad. Any action may be defined as a sales transaction, a customer acquisition or simply a click.

Cost-per-Click (CPC): Pricing based on the number of clicks an ad receives. A typical CPC range is 5 cents to $1 per click. Also referred to as pay-per-click. CPC may also refer to cost-per-customer.

Cost-per-Lead (CPL): Pricing based on the number of new leads generated by an ad. For example, a payment may be required for each visitor that clicks on an ad or successfully completes a form on the web site.

Cost-per-Order (CPO): Pricing based on the number of orders received as a result of ad placement. Also referred to as cost-per-transaction.

Cost-per-Sale (CPS): Pricing based on the number of sales transactions that the ad generates. Since users may visit a site several times before making a purchase, cookies can be used to track the user's visits from the landing page to the actual sale. Also referred to as cost-per-acquisition or pay-per-sale.

Daughter Window: An ad that runs in a separate window associated with a concurrently displayed banner. Typically in normal practice, the content and banner are rendered first and the daughter window appears a moment later.

Directory: A compilation of web sites reviewed and organized into useful categories and topics, similar to the organization of the Yellow Pages. Examples of directories are Yahoo!, About.com, and the Open Directory Project.

Dynamic Rotation Delivery of ads on a rotating, random basis. Dynamic rotation allows ads to be served on different pages of the site and exposes users to a variety of ads.

Exact Match: An ad appears when the search query exactly matches the keyword. As an example, “tennis shoes” would only match a user request for “tennis shoes” and not for “red tennis shoes,” even though the second query contains the keyword.

Exclusive: A contract that allows advertisers to purchase all inventory on a page or for chosen keywords.

Expandable Banner: A banner ad that can expand to as large as 468×240 after a user clicks on it or after a user moves the cursor over the banner.

Floating Ads: An ad that appears within the main browser window on top of a page's normal content, appearing to “float” over the top of the page.

Frequency: The number of times an ad is delivered to the same browser in a single session or time period. A site can use cookies to track frequency.

Geo-Targeting: The distribution of ads to a particular geographical area. For example, using a place name in a keyword, such as “Minnesota multimedia” or “Sacramento farm equipment.” Some search engines allow the targeting of specific countries and languages without using keyword relevance.

Impression: An ad served to a user's browser. Typically, the number of impressions determines the cost of on-line ads in CPM pricing models. This is also referred to as an exposure.

Insertion Order (I/O): A contract that specifies the details of the search advertising campaign, including placement options, keywords, ad creative, landing page, pricing, geo-targeting, language options and the like.

Interactive Ad Formats: Advertising formats, typically text-based, which encourage Internet users to take immediate action. Can include the following dynamic ad formats: banner ad, expandable banner, beyond-the-banner, button, skyscraper, pop-up ad or pop-under ad, schoskeles, interstitial ad, daughter window, click-down or click-within ad, floating ad, animated ad, jump page ad, and context integration ad.

Interstitial Ad: An ad page that appears for a short period of time before the user-requested page is displayed. Also known as a transitional ad, splash page or flash page.

Inventory: Advertising space available for purchase on a web site. Based on space projections, inventory may be specified as the number of impressions or as a single invoice. Also known as ad avail.

Jump Page Ad: A micro site reached by clicking a button or banner. The jump page itself can list several topics, which can link to the site.

Keyword: A specific word, or combination of words, entered into a search engine that results in a list of pages related to the keyword. A keyword is the context of the search engine query.

Keyword Matching Methods of selecting and organizing keywords to match the user's query. Four types of keyword matching are “Broad match”; “Exact match”; “Phrase match”; and “Negative keyword.”

Keyword Research Tools: Tools which help to find keywords, by providing statistics on how often a keyword phrase was searched, how many competing sites there are and the like.

Landing Page An active web page where Internet users “land” when they click an on-line ad. A landing page does not have to be a home page.

Link Popularity Checkers: Tools, which analyze the popularity of the link to the desired site. Particularly important in the use of Google rankings.

MODS: Marketing, Optimization and Design Standards (or Software).

Negative Keyword Negative keywords allow the elimination of searches that are known to not be related to the message. For example, if the negative keyword “−table” is added to the keyword “tennis shoes” then the ad would not appear when a user searches on “table tennis shoes.” Negative keywords are preferably used with caution, as they can eliminate a large portion of the desired audience if applied too freely.

Paid Inclusion Guaranteed inclusion on a search engine's results in exchange for payment, without any guarantee of how high the listing will appear. A paid inclusion appears to the user as an editorial listing rather than as a sponsored link.

Paid Placement Guaranteed listing with high ranking among search resulting usually in relation to specific keywords. In response to recent FTC guidelines many search engines clearly identify paid placements as “sponsored links.”

Perfect Page Tools/Page Analyzer: Using the statistics provided by these tools and analyzer, an Internet marketer can determine what the top ranking sites are doing to optimize their sites for particular keywords. This information can then be emulated to get comparable results on the search engines. Included in these tools are keyword density analyzers and metatag checkers.

Phrase Match An ad appears when the users search on the exact phrase and also when their search also contains additional terms, where the keyword phrase is in the exactly the same order. For example, a phrase match for “tennis shoes” would include “red tennis shoes” but not “shoes for tennis.” In the case of one-word keywords, there is no difference between a broad match and a phrase match.

Pop-up Ad or Pop-under-Ad: An ad that appears in a separate window or beneath the user's current page. A pop-under-ad is concealed until the top window is closed, moved, resized, or minimized. A pop-up ad is similar to a daughter window, but without an associated banner.

Portal: A web page that works as a starting point for a user's session on the Internet. Portals typically include a directory of web sites, access to web servers and shopping sites, and search facilities powered by a search engine program. Examples of portals are: AOL, Netscape, CompuServe and Earthlink.

Position Checking Tools: Tools, which permit marketers to find out where their site is ranked on search engines. Although they can be useful, they are not necessarily the best way to judge the effectiveness of an Internet marketing campaign as a whole. Typically, web site statistics programs and web site log analyzers are better for tracking the traffic from a specific search engine.

Query: A request for information, usually to a search engine or a database. Typically the user enters words or topics and the search engine returns matching results from its database. A query is typically at the center of every search engine interaction.

Reach: The total number of unique users who will be served the ad over a specific period of time. Reach is often expressed as a percent of the universe of the demographic category. This is also referred to as an unduplicated audience.

Referral Fees: Fees paid in exchange for delivering a qualified sales lead or receiving a purchase inquiry. For example, an affiliate typically drives traffic to other companies in exchange for a percentage of sales or a flat referral fee.

Relevance: A measure of how closely a search result—or a search ad—matches the user's query. Relevance is the key to harnessing the power of search advertising. The more relevant the ad, the more likely the audience will be motivated to respond to the “call-to-action.” At the same time, the relevance of the ad and/or ad's landing page can enhance the user's search experience, while irrelevant ads can cause users to ignore advertising altogether.

Remnant Inventory: Low-cost advertising space that is relatively undesirable or otherwise unsold.

Repeat Visitor: A unique visitor who has accessed a web site more than on one occasion during a specified time period.

Return on Investment (ROI): The benefit gained in return for the cost of the ad campaign. Although typically difficult to measure with accuracy, the clickthrough rate and the conversion rate combined with the advertising costs, can be used to generate an approximate ROI for an Internet advertising campaign.

Robot: A program that runs automatically without human interaction. A robot is typically endowed with some artificial intelligence, so that it can adjust to the various situations it may encounter. Two common types of robots are agents and spiders. It is also referred to as a bot.

Run-of-Site (ROS): The scheduling of ads across an entire site, often at a lower cost than the purchase of specific pages or sub-sections of the site.

Search Engine: A program that helps users find information on the Internet by an automated system that sends out a spider to the web and collects site links for its database. When a user types in a keyword or combination of keywords, the search engine sorts through the database and ranks the web sites in order of relevance. A search engine is typically distinguished from a directory and a portal, because its pages are generated by an automated program rather than by human editors. Currently popular search engines are Ask.com, AltaVista, Lycos and Google.

Search Optimization: Tactics and techniques that make it easier for spiders to find a web page, thereby contributing to a higher ranking on a list of search engine results. Basic optimization starts with listing relevant keywords in the metatags and by building clear and descriptive words into page copy, title, text hyperlinks, and image file names. Optimization can also involve designing the site on a logical link structure and by following standard HTML conventions, avoiding the use of frames, dynamic Image Maps and JavaScript for navigation. The primary purpose of search engine optimization is to expose a web site to its target market on the Internet. At present there are six types of search engine optimization tools that are available to Internet marketers. They are: Submission Tools; Position Checking Tools; Perfect Page Tools/Page Analyzers; Bidding Managers; Keyword Research Tools, and Link Popularity Checkers.

Share of Voice: A relative portion of inventory available to a single advertiser within a defined market sector over a specified time period.

Shoskeles: An animated ad that moves across the browser, usually with sound effects. It animates only long enough to play a message before settling into a stationary ad on the page.

Skyscraper: A tall, thin ad unit that runs down the side of a web page. Currently, a skyscraper can be 120×600 pixels or 160×600 pixels.

Spider: A program that automatically fetches web pages and feeds them to search engines. (It is called a “spider” because it crawls around the web.) Because the web pages contain links to and from other web pages, a spider can start almost anywhere. As soon as it recognizes a line to another web page, it goes and fetches it. Large search engines have many spiders working simultaneously. It is also sometimes referred to as a crawler.

Submission Tool Software that allows a marketer to submit each page of the site individually, or just the base URL, as if the page were on the search engine web site's “Add URL” page. Although search engines no longer typically give new priority to individually submitted pages (due to SPAM tactics), these tools work well for new web sites or to promote web sites on the hundreds of small search engines.

Syndication: An option that allows an advertiser to extend the reach of an ad by distribution on additional partner sites.

Target Audience The intended audience for an ad, usually defined in terms of specific demographics (age, income, etc.), product purchase behavior, product usage, or media usage.

Text Ad: An ad designed for text delivery, with concise, action-oriented copy linked to a web site. Because it is not accompanied by graphics or sound, text links are easy to create and can improve page download time.

Token: A tracer or tag attached by the receiving server to the address (URL) page requested by the user. A token typically lasts only through a continuous series of requests by a user, regardless of the length of the interval between requests. Tokens can be used to count unique users.

Tracking: On-line advertising can open the opportunity to track audience response throughout the life of the ad campaign. Tracking and reporting tools can help learn what is effective so that the ad can be refined. The on-line ad publisher typically will provide reports on ad impressions and clickthrough.

Unique User: A single individual or browser who accesses a site or is served unique content and/or ads. User registration cookies can identify unique users. Also referred to as a unique visitor.

Universe: The total population of the audience that is being measured by a metric.

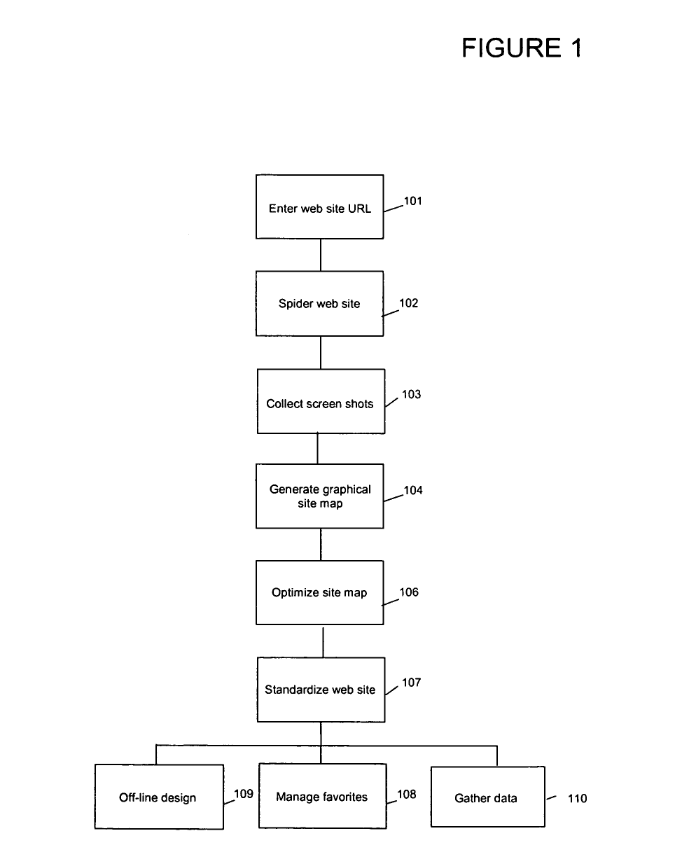

FIG. 1 shows a process diagram of the top-level steps of the present embodiment of this invention. The process of this invention starts with entering 101 a web site URL into the site map tool. The site map tool then spiders 102 the entered web site content and collects 103 a screen shot of one or more web pages of the entered web site. In the present embodiment, a screen shot is made for each web page of the entered web site. A graphical site map is generated 104 with the screen shots of the web pages of the entered web site. In the present embodiment, the site map requires little if any administrative access to the web site server to be built.

Also, in this present embodiment, the site map tool resides on a different server than the main web site and typically employs adding a site map link on every page of the main site to the main site page. A web-based administration area with a login and a password is established to manage the site map and the system of this invention.

The site map is then optimized 106 to improve search engine marketing results. By collecting screen shots of each web page and generating a graphical site map from the collected screen shots, this invention, in its present preferred embodiment, makes each and every web page visible to search engines and leverages site content and keywords for every page of the site. The optimization 106, in its present embodiment, includes tips and instructions on how to maximize search engine marketing results. The present optimization 106 is performed in an administration area where end users can add and modify keywords and related content on a page-by-page basis.

The web site content and images are standardized 107 for on-line and off-line marketing through a user-friendly web-based system. The standardization 107 tool can convert the content of a web site into multiple languages and facilitate access in the global marketplace. This standardization 107 tool, in its preferred embodiment, can recreate web sites into multiple viewing options and languages, can position the site for indexing with any or near any type of on-line database and can bring customers to the call-to-action pages. The off-line design 109 tool creates marketing materials (brochures, posters and the like) from the images and content on a web site for off-line marketing. Favorites are managed 108 in the preferred embodiment to graphically display thumbnails of bookmarks and most frequently visited sites on the web browser start (home) page. Data is gathered 110 in a data capture tool, which collects data identifying the demographic and geographic specific information about the on-line consumer and to process this information for improving Internet advertising results.

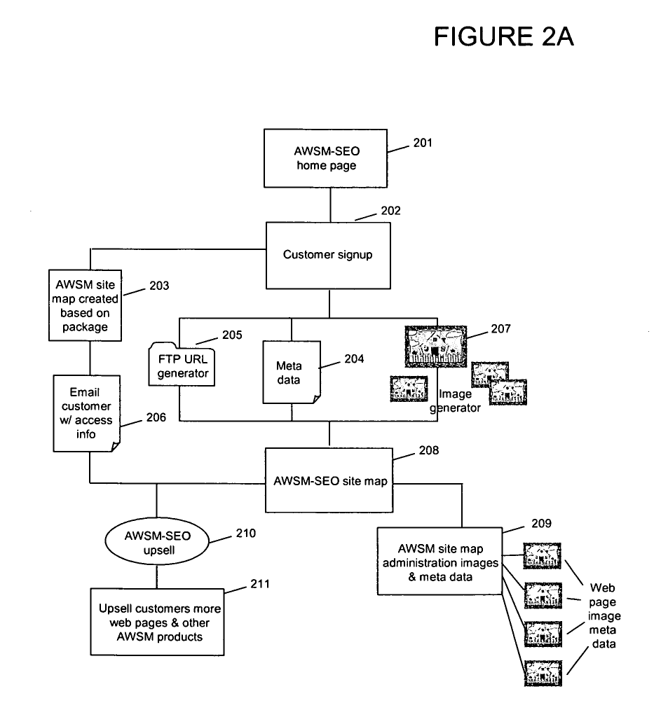

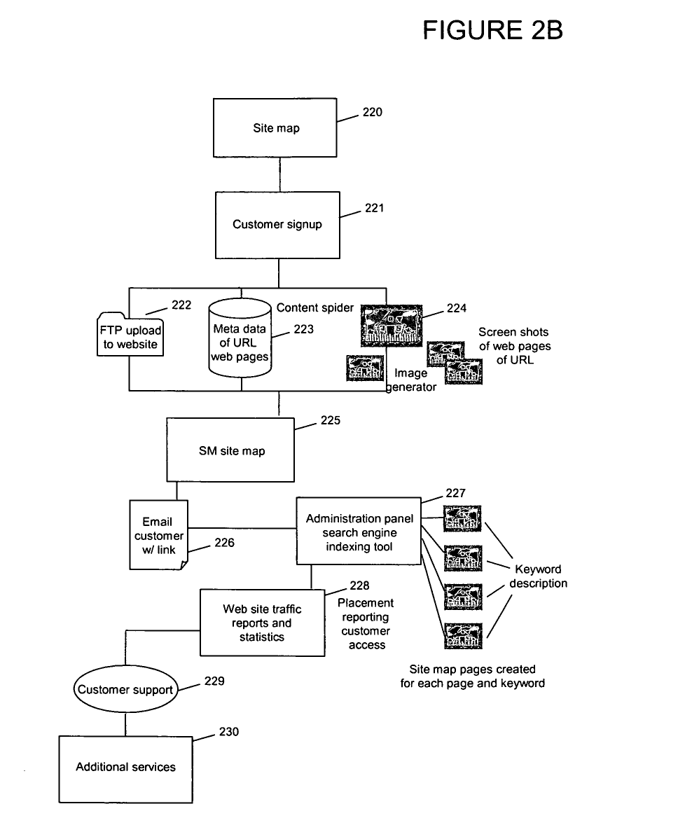

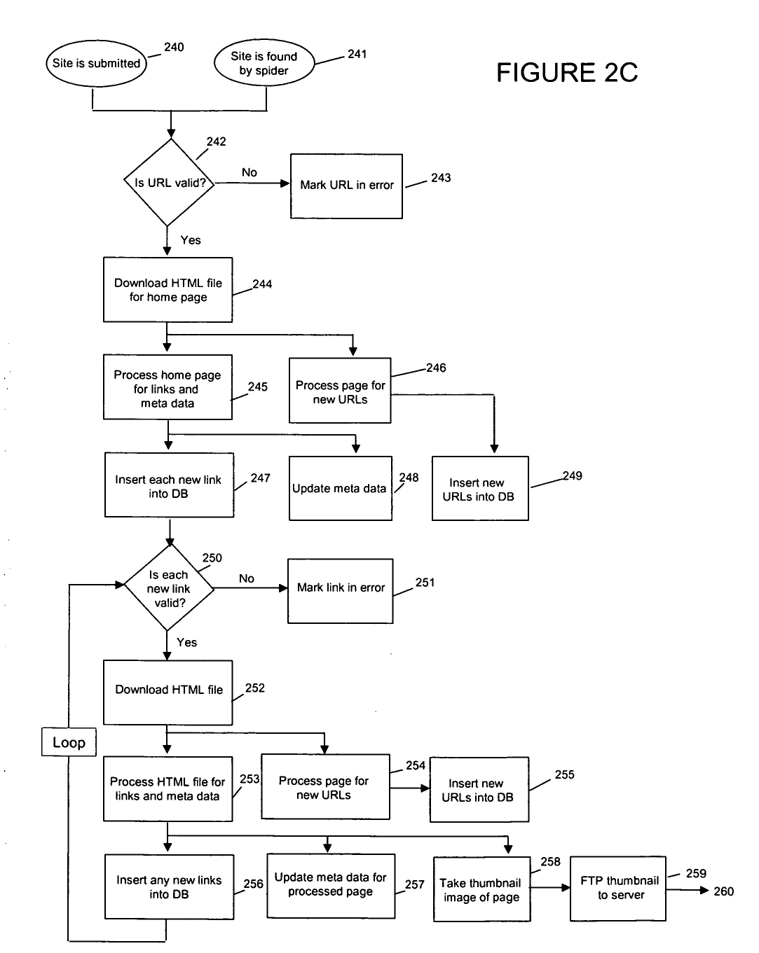

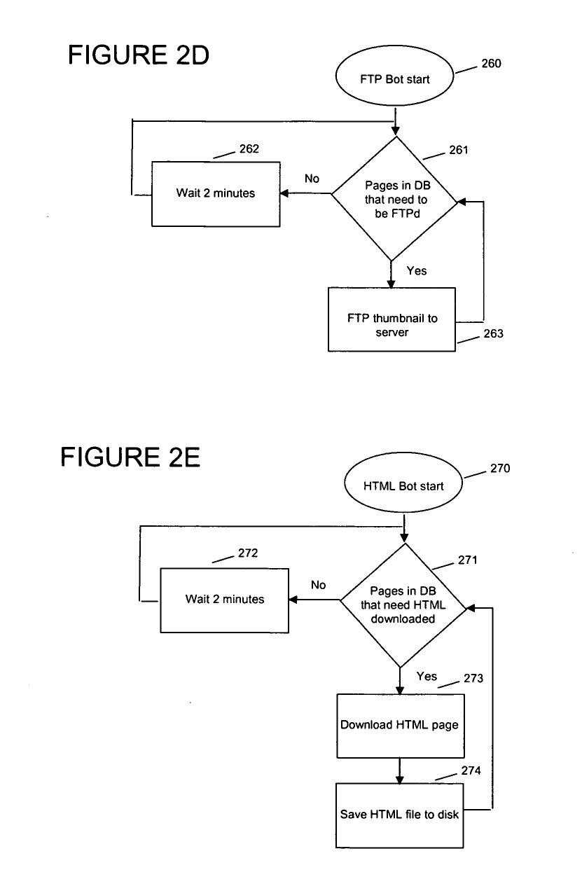

FIG. 2A is a system flow diagram of one embodiment of the disclosed system. The process home page 201 is linked to a customer sign-up screen 202, where the customer's name, company name, address, e-mail, URL, new URL, telephone number, facsimile number, keywords, business decision and the like information are collected and stored. A URL generator program 205 provides the creation of an account, using a login and password. Meta Data is collected 204.

An image generator program 203 takes screen shots of web pages of existing URLs. The site map program 207 receives the URL, Meta Data and Image Generator information and spiders the web site. Site map administration 208 uses the images and meta data to create the thumbnails 209 of the web page images. An email 206 is sent to the customer with account information. An up-sell program 210 provides a screen 211 for offering additional web pages and web page processing products.

The process begins with utilizing web site content of an existing site to build a microsite. The process emulates the look and feel of the main site to draw niche traffic from search engines to microsite call-to-action pages that generate results. The process increases web site relevancy and helps keyword ranking on major search engines for every page of the site. As a result, natural search engine traffic (the alternative to pay-per-click advertising) is capable of bringing increased traffic and sales from a specific target market. Additionally, the network of high traffic web sites, along with the database of consumer information and business intelligence (described below), are capable of simplifying the planning and execution of an on-line campaign with guaranteed results. For example, site maps can target promotions to households and businesses by demographic and psychographic interests. Additionally, site maps can also collect feedback during the program to assure immediate results and the success of future campaigns.

FIG. 2B is a system flow diagram of an alternate embodiment of the disclosed system and method. The site map home page 220 is linked to a customer sign up screen 221, where the customer's name, company name, address, email, URL, new URL, telephone number, facsimile number, keywords, business decision and the like information are collected and stored. That information is then uploaded to the web site in 222.

After registration on the sign-up screen, a customer is redirected to the login screen. A customer logs in by entering the username and password designated at registration. After logging in, a customer is able to submit a site or sites to be site mapped and is able to manage its site maps. A customer submits a site to be mapped by typing in the URL of the site desired to be mapped. The customer must also choose a sub-URL at which the site map will reside. The content of the web site is then collected through Content Spider 223 and meta data of the web pages of the URL is collected.

An image generator program 224 takes screen shots of web pages of existing URLs. The site map program 225 receives the URL, Meta Data and Image Generator after spidering the web site. An email 226 is sent to the customer with account information and link. Administrative panel and search engine indexing tool then uses the images and meta data to create keyword descriptions and site pages are created for each page and keyword in 227. Further, in 228, placement report accessing with customer access generates web site traffic reports and statistics. Customer support 229 is also provided for as well as additional services 230.

FIGS. 2C, 2D and 2E are flow charts illustrating the steps in the disclosed method. In FIG. 2C, the web site is submitted in step 240. The web site is then found by the spider in step 241. In step 242, the system determines whether the URL is valid. If it is not, then in step 243, the URL is marked in error. If, in step 242, the URL is valid, then in step 244, the system downloads the HTML file for the home page using the program shown in FIG. 2E.

In step 245, the system then processes the home page for links and meta data, Then in step 246 the system processes the page for new URLs and in step 249 inserts the new URLs into the database. In step 247 the links are also inserted into the database and in step 248, the meta data is updated. Then, in step 250, the system checks the new links that have been inserted into the database for validity. If it is not valid, the link is marked in error in step 251. If it is valid, the system downloads the HTML file in step 252 and processes the HTML file for links and meta data in step 253.

Then in step 254 the system processes the page for new URLs and in step 255 inserts the new URLs into the database. In step 256, the system inserts any new links into the data and the process repeats itself (steps 250-256). Then in step 257, the system updates the meta data for the processed page and in step 258 takes a thumbnail of that page. A thumbnail of that page in the sent to the server via file transfer protocol (FTP).

FIG. 2D illustrates the FTP program piece of the site map system that automatically uploads images that are taken during the process to the live web server so that these images can be viewed on the sitemap. In step 260, file transfer protocol (FTP) is initiated and the system determines the pages in the database that need to be transferred to the server. If the page is not available at that time (URL appears not to be valid), the system waits two minutes and tries again in step 262. This loop continues until the page is located or until some predetermined amount of time or number of attempts have passed. If the page is located, then the thumbnail is transferred to the server in step 263.

FIG. 2E illustrates the HTML program piece of the site map system that communicates with the web and makes requests to web servers to return the HTML files that have been found. In step 270, the HTML process begins and in step 271, the system determines the pages in the database that need to be downloaded. If in step 271, there are no pages waiting to be downloaded the system waits two minutes and checks again in step 272. This loop continues until the there is a page ready to be downloaded. If the page is located, then the page is downloaded in step 273 and the HTML file is saved to disk in step 274.

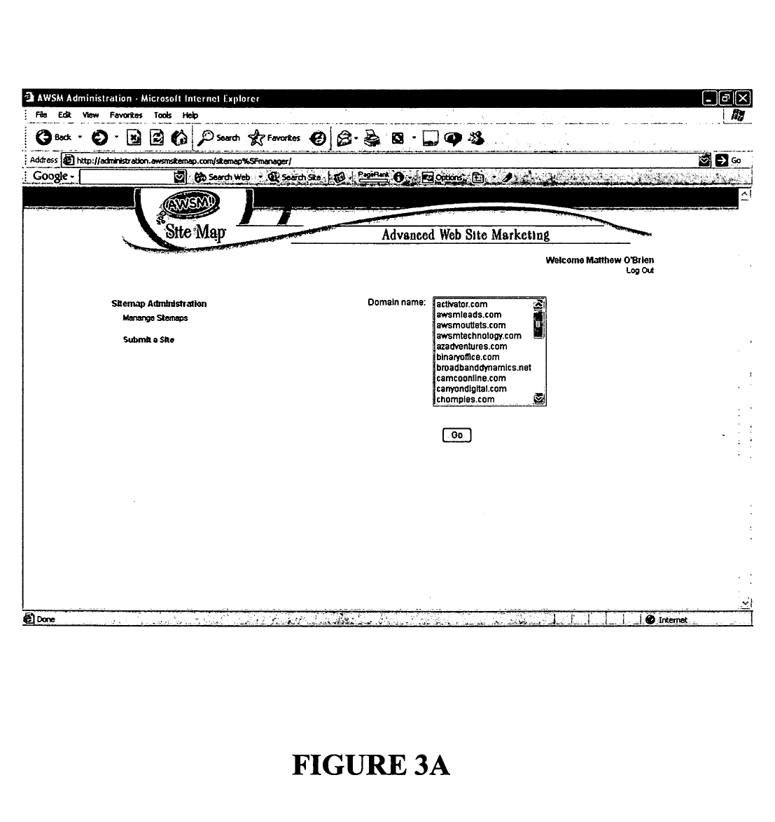

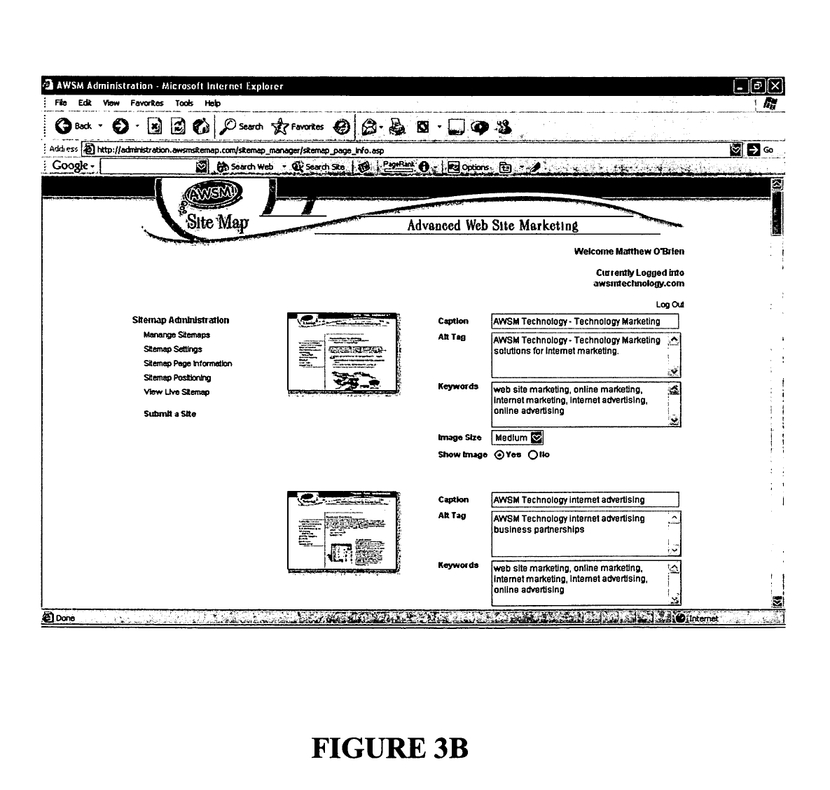

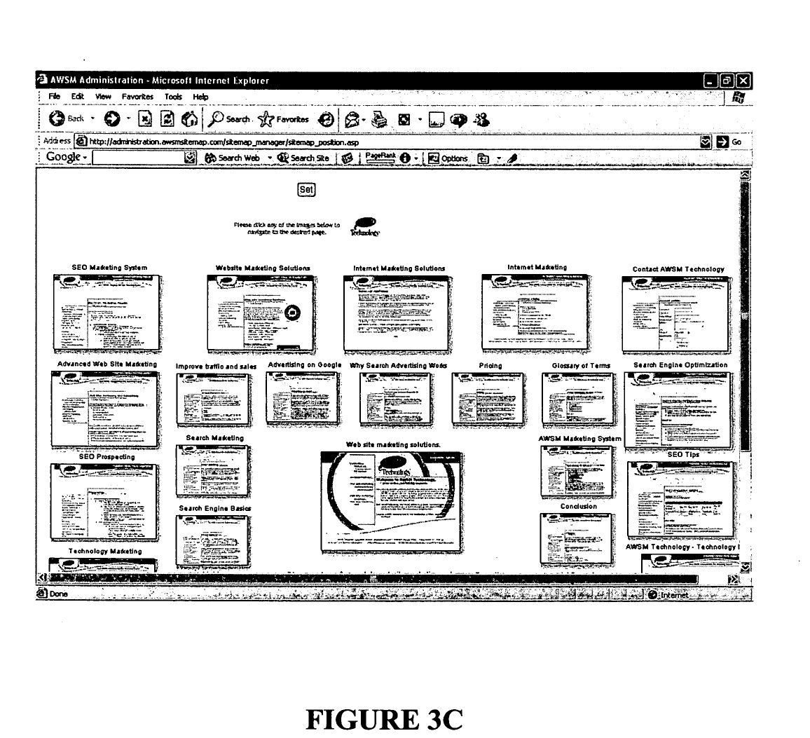

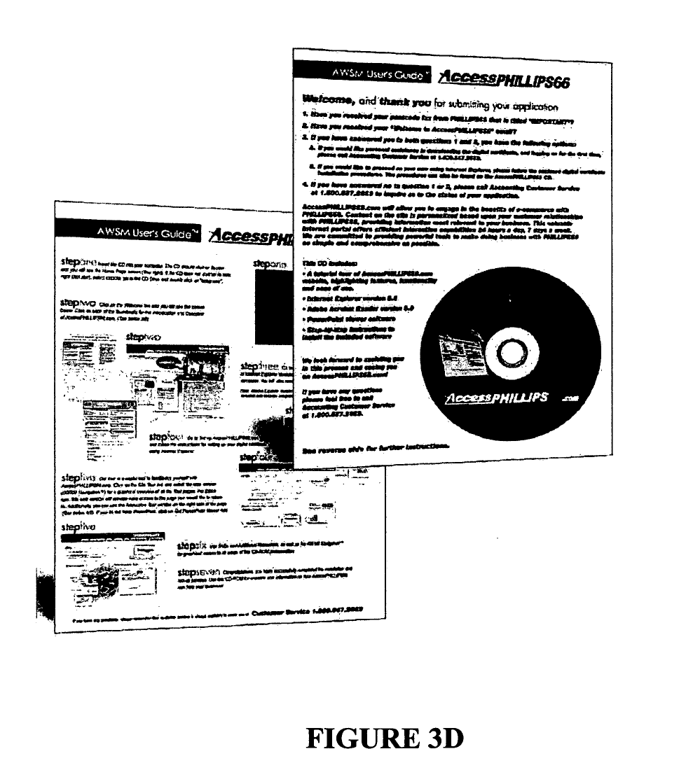

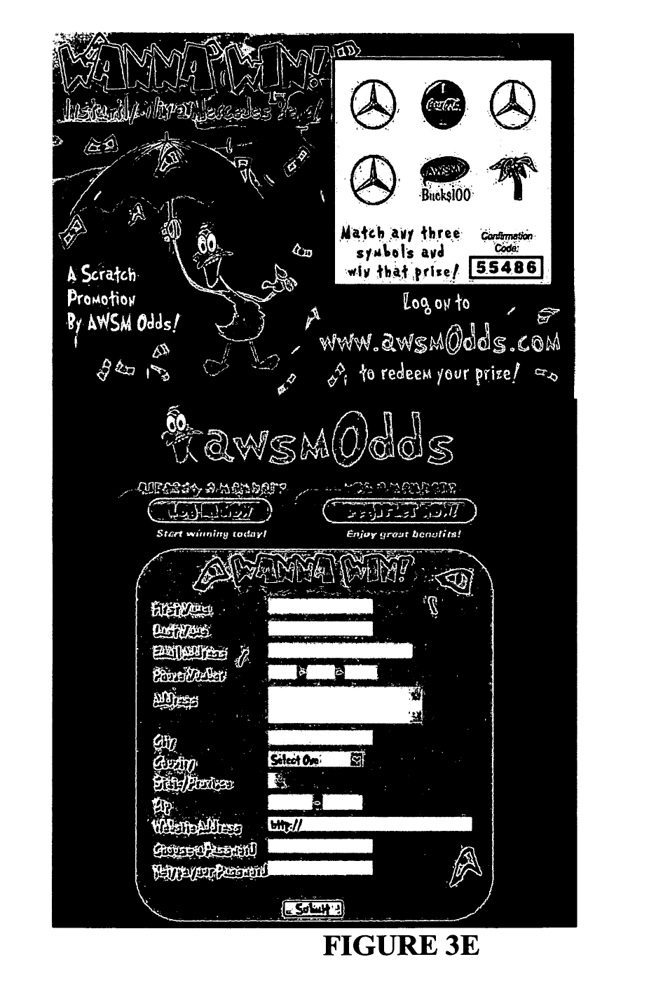

FIGS. 3A, 3B and 3C show representative screen diagrams of several steps in the present embodiment of this invention. FIG. 3A shows the present embodiment of the administration area page 301 used to manage site maps. Through the administration area, end users optimize their site map to improve search marketing results. The site map makes every page visible to search engines, leverages site content and assigns keywords for every page of the site. The optimization tool offers tips and instructions on how to for maximizing search engine marketing results. Through this administration area, end users can add and modify keywords and related content on a page-per-page basis. The site map then leverages all this content on one site map (or multiple site maps) to maximize search engine marketing results, keyword ranking and overall web site relevancy.

FIG. 3B shows the present embodiment of the database area page 302 used to maintain keywords and images. FIG. 3C shows the page layout and set tool page 303 showing the thumbnail images 304 of each of the web site pages. The thumbnail images generated can then be used in the off-line marketing component of the disclosed system and method. As shown in FIG. 3D, off-line marketing visuals may include high quality marketing brochures with a CD-ROM or DVD that provides an interactive experience to the end-user. Also, as shown in FIG. 3E, incentive-based promotions for participation and on-line data capture forms for prize redemption can be used. Branding and lead generation can also be developed as key factors for business participation.

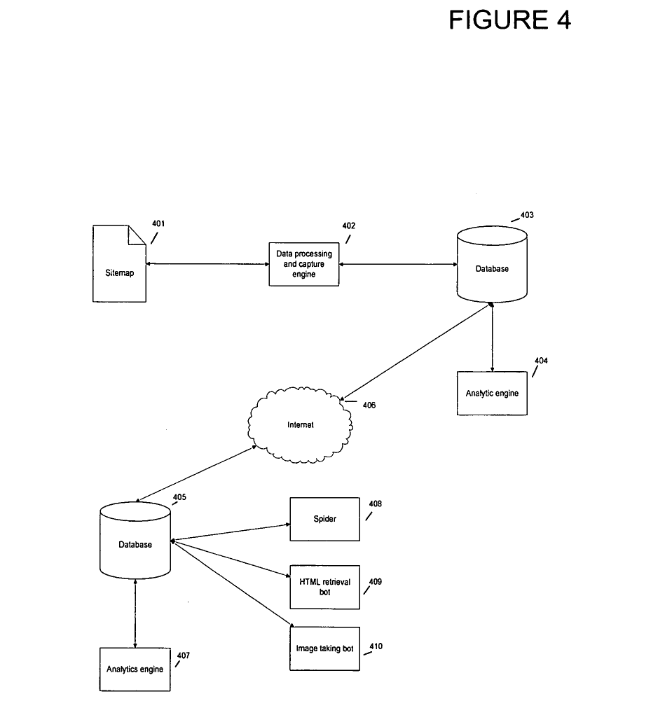

FIG. 4 shows a detailed view of the system flow between the components of the present embodiment of this invention. In the present embodiment of the invention, the start (home) page 401 is connected to through an application layer of data collection and processing 402 to a database server 403. This database server 403 stores data for use buy systems such as the sitemap homepage 401 over the web. This database server 403 communicates through the internet 406 to another database server 405 that stores larger more complete amounts of data for processes such as spidering of web sites.

The NT server 405 includes a data capture system and receives Z Frame data 404. The Internet 406 is also in communication with a second NT server 407, where spiders and the image rendering system are executed. This second NT server 407 communicates through preferences to the Linux server 403 database 409 and through a SMB/NFS link to the worldwide web 410. The Linux server 403 of an intelligent database 408.

The same database that drives MODS is available to business partners to supplement targeted marketing campaigns through the Internet, mail, phone and email. The depth and accuracy of consumer and business intelligence in intelligent database 408 represents a key feature in the partnership opportunity that exists, providing sophisticated information and the best qualified prospects to enhance internet marketing and off-line marketing.

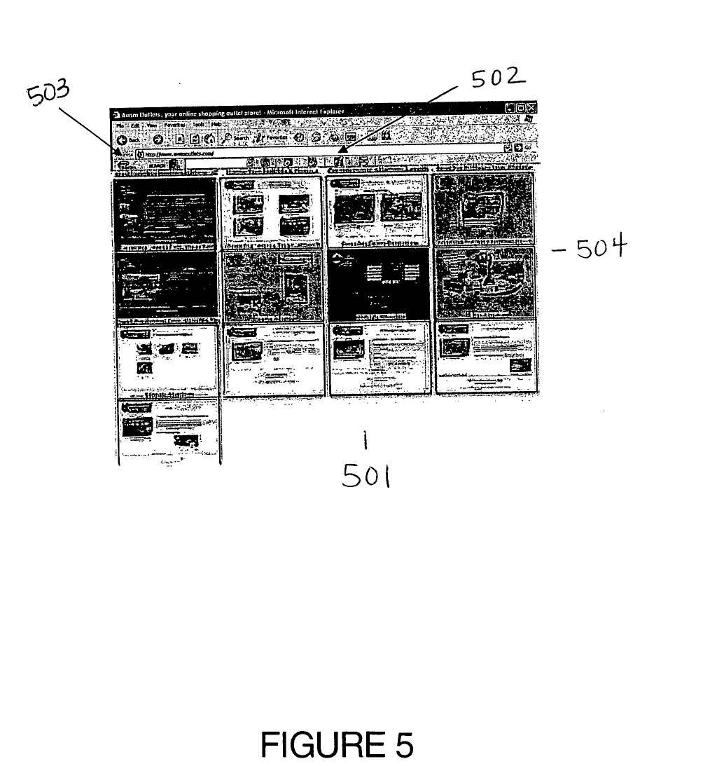

FIG. 5 shows an example of a screen diagram of the use of the favorites feature in the present embodiment of this invention. The favorites feature serves as the web browser home page to graphically display thumbnails of bookmarks and most frequently visited sites using the Site Map format. The favorites feature is capable of being installed on the consumer computer (like the Google tool bar) and will utilize a wizard to help the user create graphical bookmark favorites. Contests along with prizes will be offered to regular users. The favorites feature may include the following capabilities to (1) obtain demographic and psychographic data through the completion of a questionnaire in exchange for the free software; (2) collect real-time user data for analysis; (3) create a community of personal home pages; and (4) create a community of Site Map for e-commerce entities that want to market products and services through this portal.

Specifically, FIG. 5 shows the favorites screen 501. Upon clicking the logo 503 on the tool bar the option as to which category the current page should be added to is presented to the user. Icons 504 are added to the tool bar 502 after attaching favorite web pages. The icons 504, in the present preferred embodiment of the invention, show the present preferred thumbnails of the web site.

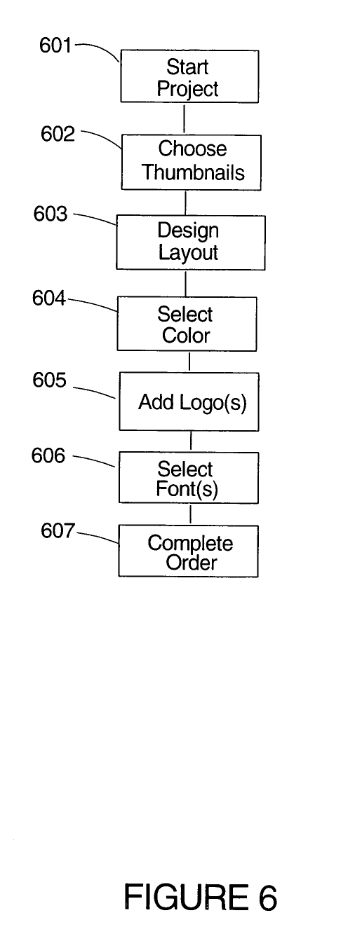

FIG. 6 shows a detailed process diagram of the off-line design 109 process of the present embodiment of this invention. The project is started 601 by picking a project from a list of descriptions to include various poster sizes, visuals, brochure pages and the like. Typically, a variety of sizes will also be available for selections. A sample area is created to provide visual examples of the different types of projects. The orientation of the project, presently either horizontal or vertical, is selected during this start project step 601.

Also, during this step 601, the number of sections is selected. A section is a block of text copy attached to a group of thumbnail images. The last sub step of the start project step 601 is the selection of a layout, from a variety of compositional layouts. Using the site map interface, the thumbnails are selected 602, thereby selecting all of the thumbnail images from the web site, which the user wishes to be included in the design project. The design interface then includes the steps of selecting 603 the design layout to give a basic structure for the project.

The color scheme is determined 604 and can be changed. In the present embodiment, the color scheme is selected using a pop-up window with a large selection of colors to pick from. Colors can be chosen for all text, text blocks as well as the background. Once all of the colors have been chose, a “Done” button returns the user to the design interface. After previewing the project in the new color scheme, the color palette can be reselected as often as necessary to achieve the desired color for the project. A logo is added 605, if desired. In the present embodiment, the logo add step 605 includes the options of uploading a logo from a standalone computer, choosing a logo that is already stored on the system server and choosing not to use a logo.

After selecting from these options, a “Done” button returns the user to the design interface. The desired fonts are selected 606. This selection 606 of desired fonts is presently accomplished through use of a font pop-up window that contains a selection of four or more basic fonts with plain, italic, bold and bold italic options. These font choices are available for title type and all secondary type. As in the color selection step 604, the user returns to the design interface after finishing the selection of fonts and the user can return to the font selection step until satisfied with the appearance of the project. Once the user is satisfied with the project, the option of viewing a large watermarked version of the project is provided and the user is given the option of downloading the completed PDF immediately or sending the PDF file to the designated printer, or to complete the order on-line and pick up at the printer at a later time, all as part of the order completion step 607.

The following disclosed system and method also offer the advantage of generating several independent revenue streams. Because the software is an ASP licensing model, the software license is capable of generating setup fees, annual licensing fees, and monthly hosting and support services. Web sites, web pages and ads are also capable of being sold on a lease rental basis. General advertisement may be a shotgun approach for advertisers using banner ads and text ads to non-specific demographics. Targeted ads may enable advertisers to select demographic profiles to showcase their banner and text ads. Specialized microsites are capable of being built for specific products and services and leased to businesses and/or entrepreneurs for the benefit of commissions from sales generated. Further, corporations can also have sponsorship opportunity for receiving net traffic from microsites that are capable of resulting in either affiliate sales, leads or brand recognition.

Additionally, the off-line advertising component including promotional games may create sponsorship revenue from large corporations to drive businesses and consumers on-line. Incentive-based offers and prizes could entice people to provide valuable customer data that helps advertisers target a specific audience. Further, a licensing fee could be charged for the print marketing piece that includes an interactive CD-ROM. Both applications drive participants on-line to call-to-action forms. This data may then be fed into the lead generation component and be capable of being sold through vertical markets to business partners and sponsors.

Finally, the disclosed system and method is capable of providing predictive models for analysis and data mining of on-line and off-line lead sources. Capturing voluntary information on web users may be enhanced through ongoing incentives to produce demographic data via games and promotions. Additionally, web surfing data is capable of being collected on an aggregate level to determine web user behavior and e-commerce habits and trends. This valuable data is capable of being available real-time and being sold as hot leads through various vertical markets, including automotive, resorts/leisure, financial/banking, retail merchants, government/military, transportation (air, sea, land), pharmaceutical (health and beauty), restaurants/chains, education, telecommunications, political and distribution.

It is to be understood that the above-described embodiments and examples are merely illustrative of numerous and varied other embodiments and applications which may constitute applications of the principles of the invention. These example embodiments are not intended to be exhaustive nor to limit the invention to the precise form, connection or choice of components, computer language or modules disclosed herein as the present preferred embodiments. Obvious modifications or variations are possible and foreseeable in light of the above teachings. These embodiments of the invention were chosen and described to provide the best illustration of the principles of the invention and its practical application to thereby enable one of ordinary skill in the art to make and use the invention, without undue experimentation. Other embodiments may be readily devised by those skilled in the art without departing from the spirit or scope of this invention and it is our intent that they be deemed to be within the scope of this invention, as determined by the appended claims when they are interpreted in accordance with the breadth to which they are fairly, legally and equitably entitled.

What is claimed is:

1. A method for optimizing web site visibility on the Internet, comprising: spidering a selected web site; collecting screen shots from a plurality of web pages from said web site; and generating a graphical site map from said collected screen shots.

2. The method of claim 1, further including collecting a plurality of screen shots from a plurality of web sites and generating the graphical site map from the collected screen shots from the plurality of web sites.

3. The method of claim 1, further including establishing top page relevancy for search engines by standardizing said web site based on said web site optimization.

4. The method of claim 3, further including distributing web page relevancy for the remaining web pages of the said web site.

5. The method of claim 3, further including optimizing said graphical site map based on said web site optimization and web site standardization.

6. An advertising method, comprising: spidering a selected web site; collecting screen shots of a plurality of web pages from said web site; and designing offline documents from said web site.

7. The method of claim 6, further including generating a graphical site map, wherein the graphical site map is used in designed the offline documents from said web site.

8. A method for promoting web sites, comprising: spidering a selected web site; collecting a screen shots of a plurality of web pages from said web site; generating a graphical site map from said collected screen shots; and gathering user data from the access of said web site.

9. The method of claim 8, further including managing a user's favorites on said web site.

10. The method of claim 8, further including collecting predetermined data from the user in exchange for managing the user's favorites on said web site.

11. A system for optimizing the visibility of web sites on the Internet, comprising: a host server computer including a web site having one or more content-based web pages including a system home page and a customer sign up page linked to said promotion system home page, and in communication with one or more distribution mediums, wherein, in response to a communication from a user computer, said host server computer directs said user computer to enter the URL of a predetermined web site, and said host server, collects meta data from the predetermined web site and stores said meta data on the host server computer on a storage medium, and said host server computer generates a graphical site map comprised of thumbnail images of web pages collected from the predetermined web site.

12. The system of claim 11, further including an image generator linked to said system home page for collecting images from the predetermined web site.

13. The system of claim 11, further including a site map administration page displaying the thumbnail images of web pages collected from the predetermined web site.

14. A computer-readable storage medium containing computer executable code for instructing a server computer to perform the steps of: spidering a selected web site; collecting screen shots of a plurality of web pages from said web site; and generating a graphical site map from said collected screen shots.

15. The computer readable storage medium of claim 14, further including computer executable code for instructing a server computer to perform the steps of determining page ranks for the remaining web pages of said web site and distributing the page ranks according to the determination.

16. The computer readable storage medium of claim 15, further including computer executable code for instructing a server computer to perform the step of optimizing said graphical site map based on the page rank distribution.

17. The computer readable storage medium of claim 16, further including computer executable code for instructing a server computer to perform the step of standardizing said web site based on said optimization.

18. The computer readable storage medium of claim 16, further including computer executable code for instructing a server computer to perform the step of generating off-line documents from said graphical site map.
